(19) United States
(12) Patent Application Publication
(10) Pub. No.: US 2026/0038493 A1
(43) Pub. Date: Feb. 5, 2026

(54) METHOD AND SYSTEM FOR ROBOT CONVERSATION GENERATION USING LLM SERVER BASED ON MULTI-MODAL EMOTION RECOGNITION

(71) Applicant: SEOUL NATIONAL UNIVERSITY R&DB FOUNDATION, Seoul (KR)

(72) Inventors: Wan CHOI, Seoul (KR); Bumjun KIM, Seoul (KR); Yoon HUH, Seoul (KR); Eunsoo KIM, Seoul (KR)

(73) Assignee: SEOUL NATIONAL UNIVERSITY R&DB FOUNDATION, Seoul (KR)

(21) Appl. No.: 19/287,054

(22) Filed: Jul. 31, 2025

(30) Foreign Application Priority Data
Aug. 2, 2024 (KR) 10-2024-0103363
Mar. 31, 2025 (KP) 10-2025-0041561

(51) Int. Cl. G10L 15/18; B25J 11/00; G06V 10/40; G06V 10/764; G06V 10/82; G06V 40/16; G10L 15/02; G10L 15/16; G10L 15/183; G10L 15/30; G10L 25/63

(52) U.S. Cl. CPC G10L 15/1815; B25J 11/0005; G06V 10/40; G06V 10/764; G06V 10/82; G06V 40/168; G06V 40/174; G10L 15/02; G10L 15/16; G10L 15/183; G10L 15/30; G10L 25/63

(57) ABSTRACT

A conversation generation system of a robot according to one embodiment may perform operations of acquiring, by the robot, the speech and image of an uttering user; encoding, by the robot, the speech and the image to generate emotional semantic information, and encoding the speech to generate contextual semantic information to transmit the contextual semantic information and the emotional semantic information to the LLM server; decoding, by the LLM server, the emotional semantic information to extract the user's emotional information derivable from the speech and the image, decoding the contextual semantic information to extract contextual information including text included in the speech, and applying a RAG technique to the emotional information and the contextual information to generate augmented information; inputting, by the LLM server, the emotional information, the contextual information, and the augmentation information into an LLM model to derive a response of the LLM model to the contextual information reflecting the emotional information; encoding, by the LLM server, the response to generate response semantic information and transmit it to the robot; and decoding, by the robot, the response semantic information to output a response to the user's utterance.

### TECHNICAL FIELD

The present disclosure relates to a multi-modal sensing technology, and more particularly, to a technology of generating large language model-based conversations in consideration of emotions by utilizing multi-modal data, and applying semantic communication to support efficient data transmission between a robot and an LLM server.

Meanwhile, this application was supported by the following national research development projects.
Subject Identification Code: 2710008234
Grant Number: 00398948
Name of Ministry: Ministry of Science and ICT
Name of Project Management (Specialized) Organization: Institute for Information & communication Technology Planning & evaluation
Research Project Name: Broadcasting and Communications Industry Technology Development
Research Subject Name: Next-Generation Semantic Communication Network Research Lab
Name of Project Performing Organization: Kwangwoon University Industry-Academic Cooperation Foundation
Research Period: Apr. 1, 2024 to Dec. 31, 2024

### BACKGROUND ART

With the recent advancement of artificial intelligence technology, a conversation system utilizing a large language model (LLM) is being utilized in various fields. An LLM is trained based on massive text data, and is widely used in a customer service chatbot, a virtual assistant, an educational support system, and the like, and performs the role of providing useful information in a conversation with a human.

An existing LIM-based conversation system works by analyzing a text input and generating an appropriate answer to the context. This approach is limited in that it can only process text, and has a limitation in that it does not reflect the emotional state or non-verbal expression of a conversation partner. In an actual human-human conversation, various non-verbal elements such as a speech intonation, a facial expression, and a gesture play an important role and influence the flow and atmosphere of the conversation.

However, since an existing LLM-based conversation model generates a text-based response without considering those factors, it is difficult to understand or appropriately respond to emotions. As a result, a user may feel uncomfortable or receive an inappropriate response, which may reduce the reliability and usability of an artificial intelligence-based conversational system.

In addition, an existing LLM-based conversation system often adopts a structure that generates questions and answers after transmitting the conversation content to the LLM server. This method requires high calculation resources, and the response speed may decrease depending on the network environment. In particular, in situations where real-time conversation is required, latency issues arise, making natural interaction difficult and disrupting the flow of the conversation. Therefore, a technological approach is required to improve the existing simple text-based conversation model so as to create more human-like conversations and allow natural interactions.

Therefore, in order to solve the problems of the existing conversation system and implement a more human-friendly AI conversation system, the present disclosure proposes a technology that allows an LLM-based conversation system to generate more natural emotional responses by considering not only uttered text but also human emotional information.

### CITATION LIST

### Patent Literature

Korean Patent Publication No. 10-2025-0014837

### SUMMARY OF INVENTION

### Technical Problem

The present disclosure aims to provide an LLM-based conversation generation method that allows natural conversation generation that reflects the emotions of a conversation partner. To this end, multi-modal sensing technology is utilized to collect and analyze a user's speech and facial expressions so as to seek to precisely understand the user's emotions.

In addition, the present disclosure seeks to apply a fine-tuning-based training technique that can effectively reflect emotional information while reducing a calculation burden of a large-capacity LLM to support smooth response generation in a real-time conversation environment.

Moreover, the present disclosure seeks to improve a response speed of a conversation reflecting emotions by optimizing data transmission between a robot and an LLM server by utilizing a semantic communication technique.

Meanwhile, technical problems of the present disclosure are not limited to the above-mentioned problems, and other technical problems which are not mentioned herein will be clearly understood by those skilled in the art from the description below.

### Solution to Problem

A method of performing by a robot conversation generation system including a robot and an LLM server may include operations of acquiring, by the robot, the speech and image of an uttering user; encoding, by the robot, the speech and the image to generate emotional semantic information, and encoding the speech to generate contextual semantic information to transmit the contextual semantic information and the emotional semantic information to the LLM server; decoding, by the LLM server, the emotional semantic information to extract the user's emotional information derivable from the speech and the image, decoding the contextual semantic information to extract contextual information including text included in the speech, and applying a RAG technique to the emotional information and the contextual information to generate augmented information; inputting, by the LLM server, the emotional information, the contextual information, and the augmentation information into an LLM model to derive a response of the LLM model to the contextual information reflecting the emotional information; encoding, by the LLM server, the response to generate response semantic information and transmit it to the robot; and decoding, by the robot, the response semantic information to output a response to the user's utterance.

Furthermore, the speech may include text information and audio information of content uttered by the user, and the image may include image information including the user's face object.

Furthermore, the generating of the emotional semantic information may include encoding the speech and the image based on a pre-trained emotional semantic encoder to generate emotional semantic information.

Furthermore, the emotional semantic encoder may include a CNN-based network that analyzes a frequency spectrum of the speech to extract speech features.

Furthermore, the emotional semantic encoder further may include a ResNet-based network that extracts image features from a user's facial expression included in the image.

Furthermore, the generating of the contextual semantic information may include encoding the speech based on a pre-trained contextual semantic encoder to generate contextual semantic information.

Furthermore, the contextual semantic encoder may include a speech-to-text (STT) network that converts speech into text.

Furthermore, the contextual semantic encoder may further include a text embedding network that extracts text features from the converted text.

Furthermore, the extracting of the emotional information may include decoding the emotional semantic information based on a pre-trained emotional semantic decoder to extract a user's emotional information derivable from the speech and the image.

Furthermore, the emotional semantic decoder may include a softmax layer that converts the emotional semantic information into a preset emotional class probability distribution to output emotional information including information on the probability distribution.

Furthermore, the emotional semantic information may include speech features extracted by analyzing the frequency spectrum of the speech and image features extracted from the user's facial expression included in the image, and the emotional semantic decoder may include a cross-attention layer that generates a context vector that combines the features for the speech features and the image features by applying a cross-attention mechanism; and a softmax layer that converts the context vector into a preset emotion class probability distribution to output emotion information including information on the probability distribution.

Furthermore, the extracting of the context information may include decoding the contextual semantic information based on a pre-trained context semantic decoder to extract context information including text included in the speech.

Furthermore, the contextual semantic decoder may include a transformer-based natural language generation model that converts text features included in the contextual semantic information into natural language sentences.

Furthermore, the deriving of the response may include tokenizing, by the server, the emotional 1 information and the contextual information based on a tokenizer and inputting each token into the LLM model to derive a response to the contextual information reflecting the emotional information.

Furthermore, the encoding of the response may include generating response semantic information from the response based on a pre-trained response semantic encoder including a transformer-based embedding model encoded by the LLM server, and the decoding of the response semantic information may include restoring, by the robot, the response from the response semantic information based on a pre-trained response semantic decoder including a transformer-based natural language generation model.

Furthermore, the training of an encoder included in the robot and a decoder and an LLM model included in the LLM server may be designed in a structure in which an entire process from the acquiring operation to the outputting operation is performed in a single training device to train in an end-to-end learning manner in which the parameters of the encoder, the decoder and the LLM model are updated together so as to minimize a loss between a predicted value and a correct value output as the single training device performs the acquiring operation or the outputting operation on the training data, then the encoder that has completed training may be stored in the robot, and the decoder and the LLM model that have completed training may be stored in the LLM server.

Furthermore, the LLM model may fine-tune, based on a low-rank adaptation (LORA) technique, the parameters of a LoRA adapter so as to optimize the generation of a response reflecting the emotional semantic information and contextual semantic information by the LoRA adapter additionally trained by the single training device while maintaining the parameters of a basic LLM model.

Furthermore, the encoder may include an emotional semantic encoder that encodes, by the robot, the speech and the image to generate emotional semantic information and a contextual semantic encoder that encodes the speech to generate contextual semantic information, the decoder may include an emotional semantic decoder that decodes the emotional semantic information to extract the user's emotional information derived from the speech and the image, and a contextual semantic decoder that decodes the contextual semantic information to extract contextual information including text included in the speech, and the LLM model may include a tokenizer that tokenizes the emotional information and the contextual information, and an LLM layer that receives each token as an input to derive an LLM response for the contextual information reflecting the emotional information.

A robot conversation generation system including a robot and an LLM server according to one embodiment may performing operations of acquiring, by the robot, the speech and image of an uttering user; encoding, by the robot, the speech and the image to generate emotional semantic information, and encoding the speech to generate contextual semantic information to transmit the contextual semantic information and the emotional semantic information to the LLM server; decoding, by the LLM server, the emotional semantic information to extract the user's emotional information derivable from the speech and the image, decoding the contextual semantic information to extract contextual information including text included in the speech, and applying a RAG technique to the emotional information and the contextual information to generate augmented information; inputting, by the LLM server, the emotional information, the contextual information, and the augmentation information into an LLM model to derive a response of the LLM model to the contextual information reflecting the emotional information; encoding, by the LLM server, the response to generate response semantic information and transmit it to the robot; and decoding, by the robot, the response semantic information to output a response to the user's utterance.

A computer program stored on a computer-readable recording medium according to one embodiment may include instructions that perform operations of, when a server and a client terminal perform predetermined operations in a robot conversation generation system, acquiring, by the robot, the speech and image of an uttering user; encoding, by the robot, the speech and the image to generate emotional semantic information, and encoding the speech to generate contextual semantic information to transmit the contextual semantic information and the emotional semantic information to the LLM server; decoding, by the LLM server, the emotional semantic information to extract the user's emotional information derivable from the voice and the image, decoding the contextual semantic information to extract contextual information including text included in the speech, and applying a RAG technique to the emotional information and the contextual information to generate augmented information; inputting, by the LLM server, the emotional information, the contextual information, and the augmentation information into an LLM model to derive a response of the LLM model to the contextual information reflecting the emotional information; encoding, by the LLM server, the response to generate response semantic information and transmit it to the robot; and decoding, by the robot, the response semantic information to output a response to the user's utterance.

### Advantageous Effects of Invention

The present disclosure may provide an LLM-based conversation generation method in consideration of the emotions of a conversation partner, thereby allowing an LLM-based conversational robot to interact more naturally and emotionally with a human. In particular, unlike a method in which the existing text-based conversation model generates a response by analyzing only the context, the present disclosure may precisely analyze human emotions by utilizing multi-modal sensing. This may make the flow of the conversation smoother and provide an appropriate response to the emotional state of the conversation partner so as to improve the user experience.

In addition, the present disclosure may improve response speed by optimizing data transmission between a robot and an LLM server by introducing a semantic communication method to maintain real-time nature of the conversation, and effectively reflect emotional elements of the conversation while minimizing a calculation burden by utilizing the fine-tuning technique of an LLM.

Through this, the present disclosure not only provides natural conversations that reflect emotions, but also has high practicality that can be utilized in various fields such as customer service, healthcare, and education.

Meanwhile, the effects of the present disclosure may not be limited to the above-mentioned effects, and other technical effects which are not mentioned herein will be clearly understood by those skilled in the art from the description below.

### BRIEF DESCRIPTION OF DRAWINGS

FIG. 1 is a configuration diagram of a conversation generation system of a robot according to one embodiment.

FIG. 2 is a configuration diagram of a robot and an LLM server according to one embodiment.

FIG. 3 is a flowchart of an operation performed by a robot and an LLM server according to one embodiment.

FIG. 4 is an exemplary diagram showing a structure of an encoder used in a robot and a decoder used in an LLM server according to one embodiment.

FIG. 5 is an exemplary diagram showing a structure of an LLM model used in an LLM server according to one embodiment.

FIG. 6 is an exemplary diagram for explaining an embodiment in which an LLM model is mounted on a robot itself according to one embodiment.

FIG. 7 is an exemplary diagram for explaining a hybrid type conversation generation process in which a robot and an LLM server capable of utilizing an LLM model and a RAG technique interact with each other according to one embodiment.

### DESCRIPTION OF EMBODIMENTS

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

Hereinafter, various embodiments of the present disclosure will be described with reference to the accompanying drawings. However, it should be understood that the embodiments are not intended to limit the present disclosure to specific embodiments, and include various modifications, equivalents, and/or alternatives of the embodiments of the present disclosure.

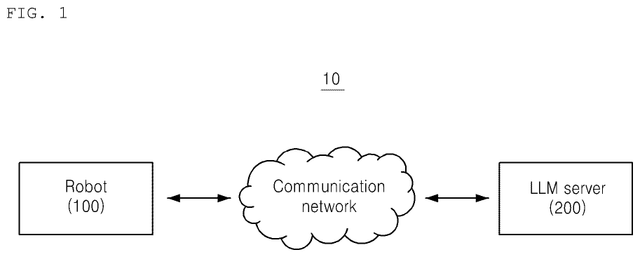

FIG. 1 is a configuration diagram of a robot conversation generation system 10 (hereinafter, referred to as a ‘system 10’) according to one embodiment.

Referring to FIG. 1, the system 10 may include a robot 100 and an LLM server 200 (hereinafter referred to as a ‘server 200’).

The robot 100 may perform the role of receiving a user's utterance, communicating with the server 200, receiving an appropriate response to the user's utterance, and then outputting the response. For example, the robot 100 may detect the user's speech, transmit information on facial expression recognition to the server 200, receive a response generated from the server 200, and output it to the user through the speech or screen.

The server 200 may understand the context of the conversation based on data transmitted from the robot 100, and perform the role of generating a response reflecting the user's emotional state. To this end, the server 200 may be mounted with a pre-trained large language model (hereinafter referred to as an ‘LLM model’), and may provide user-tailored conversations through sentiment analysis and natural language understanding.

The reason why the robot 100 and the server 200 have separate structures in this embodiment is to consider the high calculation cost of the LLM model and the efficiency of real-time conversation. In general, an LLM model, which is a neural network model including billions of parameters, requires high-performance GPUs or TPUs. Meanwhile, an edge device such as the robot 100 has limited calculation performance and memory, and therefore, directly operating the LLM model may be inefficient. Accordingly, a hardware burden on the robot 100 may be minimized by designing the server 200 to perform the emotion analysis, context processing, and response generation tasks that require intensive calculation.

Through this, the present disclosure proposes the system 10 that generates a large language model-based conversation in consideration of the user's emotions by utilizing multi-modal data including the speech and image of an uttering user, and supports efficient data transmission between a robot and an LLM server by applying semantic communication.

Hereinafter, a specific configuration of the robot 100 and the server 200 constituting the system 10 of the present disclosure and an operation of the robot 100 and the server 200 will be examined.

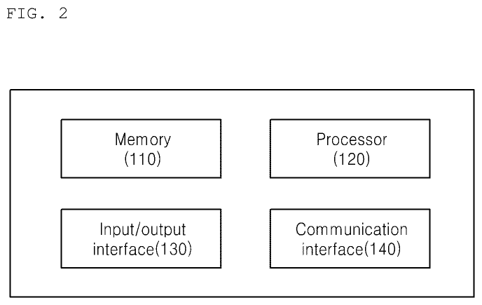

FIG. 2 is a configuration diagram of the robot 100 and the server 200 according to one embodiment.

Referring to FIG. 2, the robot 100 and the server 200 according to one embodiment may each include a memory 110, a processor 120, an input/output interface 130, and a communication interface 140.

The memory 110 may store data acquired from an external device or data generated by itself. The memory 110 may store instructions that can perform an operation of the processor 120. For example, the memory 110 may store an encoder, a decoder, an LLM model, and the like, which will be described later.

The processor 120 is a calculation device that controls an overall operation. The processor 120 may execute instructions stored in the memory 110. The operation of the robot 100 and the server 200 according to an embodiment of the disclosure may be understood as an operation performed by the processor 120.

The input/output interface 130 may include a hardware interface or software interface that inputs and outputs information.

The communication interface 140 allows information to be transmitted and received through a communication network. To this end, the communication interface 140 may include a wireless communication module or a wired communication module.

The robot 100 and the server 200 may be implemented as various types of devices capable of performing calculations through the processor 120 and transmitting and receiving information through a network. For example, it may be implemented in a form of a server, a computer device, a portable communication device, a smart phone, a portable multimedia device, a laptop, a tablet PC, and the like, but is not limited to those examples.

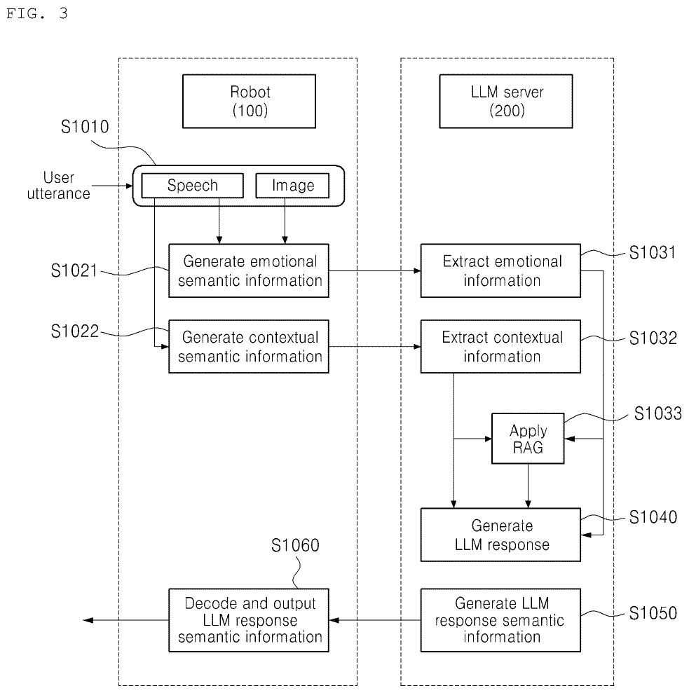

FIG. 3 is a flowchart of an operation performed by the robot 100 and the server 200 may according to one embodiment. The operation of the robot 100 and the server 200 according to an embodiment of FIG. 3 may be understood as an operation performed by the processor 120.

Each step disclosed in FIG. 3 is only a preferred embodiment in achieving the objectives of the present disclosure, and some steps may be added thereto or deleted therefrom as needed, and any one step may be included in another step to be performed. The order of respective operations disclosed in FIG. 3 is only arranged for convenience of understanding, and such an order is not limited to a time series order, and the order may be changed and operated differently depending on the designer's choice.

Referring to FIG. 3, in step S1010, the robot 100 may acquire the speech and image of a user uttering to the robot 100. For example, the speech may include text information and audio information of content uttered by the user, and the image may include image information including the user's face object. Through this, the robot 100 may acquire multi-modal information including not only the content of the user's utterance, but also phonetic features such as intonation, speed, and intensity of the voice, and non-verbal expressions such as facial expression, gaze, and gesture.

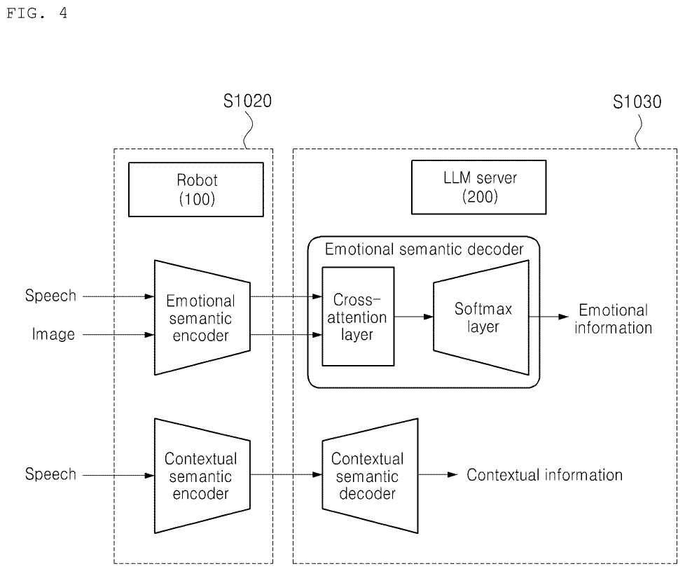

In steps S1020 and S1030 to be described later, FIGS. 3 and 4 will be referenced together.

FIG. 4 is an exemplary diagram showing a structure of an encoder used in the robot 100 and a decoder used in the server 200 according to one embodiment.

In step S1020, the robot 100 may encode the acquired speech and image to generate semantic information and transmit it to the server 200.

In general, when the robot 100 transmits the original data (speech and image of S1010) as it is to the server 200, a burden of processing large amounts of data may increase and a real-time response speed may decrease due to excessive consumption of network bandwidth. Accordingly, the present disclosure may allow smooth real-time communication between the robot 100 and the LLM server 200, and in order to improve the accuracy and response speed of conversation, semantic information, which is a compressed form of only essential information of the original data, may be generated and transmitted to the server 200, thereby reducing the amount of data transmission and performing rapid conversation processing in real time.

Specifically, in step S1021, the robot 100 may generate emotional semantic information by encoding the user's speech and image.

To this end, the robot 100 may utilize a pre-trained emotional semantic encoder to analyze the user's speech and image, respectively, and generate emotional semantic information in a form of compressed essential information of the speech and image.

As an example, an emotional semantic encoder may include a CNN-based network that extracts speech features by analyzing a frequency spectrum of the speech. In this process, the speech signal may be input into a CNN network subsequent to a preprocessing process such as mel-spectrogram transformation and Fourier transform, and the CNN-based network may analyze core elements that reflect the emotional state such as pitch, energy, formant, and syllable length of the speech to generate speech features in a vector form.

As an example, an emotional semantic encoder may include a ResNet-based network that extracts image features from the user's facial expression included in the image. In this process, the input image (e.g., video frame) may be analyzed through a face detection and normalization process, and the ResNet-based network may extract fine features such as eyebrow movement, mouth corner tilt, eye opening and closed state, and forehead wrinkle changes, and generate image features in a vector form that can infer emotional states from facial expressions.

Additionally, in step S1022, the robot 100 may encode the user's speech to generate contextual semantic information.

To this end, the robot 100 may perform a process of converting speech into text and then converting the corresponding text into a vector by utilizing a pre-trained contextual semantic encoder. Contextual semantic information may include information that is converted into a vector representation that can be processed by the LLM model while maintaining the core meaning of the content of the utterance.

As an example, a contextual semantic encoder may include a speech-to-text (STT) network that converts speech into text, and a text embedding network that converts the converted text into a vector.

For example, the STT network may convert the user's speech into text by utilizing a transformer-based speech recognition model (e.g., Whisper, Wav2Vec 2.0, DeepSpeech). Additionally, a natural language embedding model such as BERT, Sentence-BERT (SBERT), ROBERTa, FastText, Word2Vec, and T5 may be applied to the text embedding network to express the converted text in a vector form.

The emotional semantic information and contextual semantic information generated in this manner may be transmitted to the server 200 by converting the semantic features of the original speech and image into a compressed state. Accordingly, the present disclosure may reduce a network load due to original data transmission, and secure a fast response speed required in a real-time conversation system.

In step S1030, the server 200 may decode the semantic information received from the robot 100 to derive specific information to be restored from the original data (speech and image of S1010).

Specifically, in step S1031, the robot 100 may decode emotional semantic information to extract emotional information that can be derived from the user's speech and image.

To this end, the server 200 may decode the received semantic information using a pre-trained emotional semantic decoder, and perform a process of predicting the user's emotional state.

As an example, an emotional semantic decoder may include a softmax layer that converts emotional semantic information into a preset emotional class probability distribution and outputs emotional information including the converted probability distribution. For example, the softmax layer may decode emotional semantic information and convert it into probability values for predefined emotion classes such as happiness, sadness, anger, and surprise. The server 200 may use information on those probability values as emotional information of the user.

Meanwhile, in the emotional semantic decoder, the softmax layer may individually input speech features and image features, respectively, analyze them, and output emotional information, but as another embodiment, the emotional semantic decoder may include a network structure in which a cross-attention layer is arranged in front of the softmax layer, as shown in FIG. 4.

As an example, the cross-attention layer may reflect a correlation between speech features and image features within emotional semantic information to perform the role of allowing a more sophisticated emotion prediction. In this case, the cross-attention layer may infer emotional states in consideration of the complementary relationship between speech features and image features, rather than interpreting them independently. For example, when the emotional intensity is high in the speech but the facial expression lacks clear emotional cues, a cross-attention layer may reflect the speech information more strongly to perform an emotion prediction. Additionally, when emotions are clearly revealed in facial expressions (e.g., smiling, frowning, etc.), the cross-attention layer can perform emotion classification by further emphasizing image features.

The emotional semantic decoder that includes such a cross-attention layer may improve the accuracy of an emotion prediction by weighting more reliable features in a specific situation, rather than simply reflecting an average of emotional features extracted independently from the speech and image. Accordingly, the softmax layer of the emotional semantic decoder may receive a context vector generated through the cross-attention layer as an input, and output final emotional information through the softmax layer that converts an emotional class into a probabilistic distribution.

As a result, the emotional semantic decoder with cross-attention is designed to allow more intuitive and reliable emotion analysis by utilizing multi-modal information in an integrated manner during the emotion recognition process.

Additionally, in step S1032, the robot 100 may decode contextual semantic information to extract contextual information including text included in the speech. To this end, the server 200 may perform a process of decoding received contextual semantic information by utilizing a pre-trained contextual semantic decoder and restoring contextual information including the user's utterance text.

As an example, the contextual semantic decoder may include a transformer-based natural language generation model that converts contextual semantic information into natural language sentences. In this process, the contextual semantic decoder may apply natural language understanding (NLU) and context enhancement techniques to compensate for semantic information or conversation flow that can be lost during a text conversion process.

For example, the contextual semantic decoder may decode contextual semantic information by utilizing a pre-trained BERT, GPT, or T5-based context retrieval model, thereby extracting contextual information that maintains the flow of the conversation rather than simple text conversion. Additionally, the contextual semantic decoder may include a recurrent neural network (RNN), a transformer, or an attention-based network to reflect past utterance history or recent conversation context. By applying this structure, unlike simple text conversion, contextual information may be restored into text that is contextually natural and has enhanced meaning.

Additionally, in step S1033, the robot 100 may retrieve augmented information related to contextual information and emotional information from an external DB or a local DB based on a retrieval-augmented generation (RAG) technique of the server 200 to retrieve appropriate external information based on contextual information and emotional information.

To this end, the server 200 utilizes the RAG technique based on the emotional information decoded in step S1031 and the contextual information restored in step S1032 to retrieve an external document or piece of knowledge that matches the context and emotional state of the corresponding utterance. In this case, the retrieval target may be various forms of external knowledge such as domain knowledge databases, news, in-house documents, FAQs, and user histories. The retrieved augmented information is utilized as an input for generating an LLM response along with emotional information and contextual information, thereby allowing the server 200 to generate a more situationally appropriate and practical response.

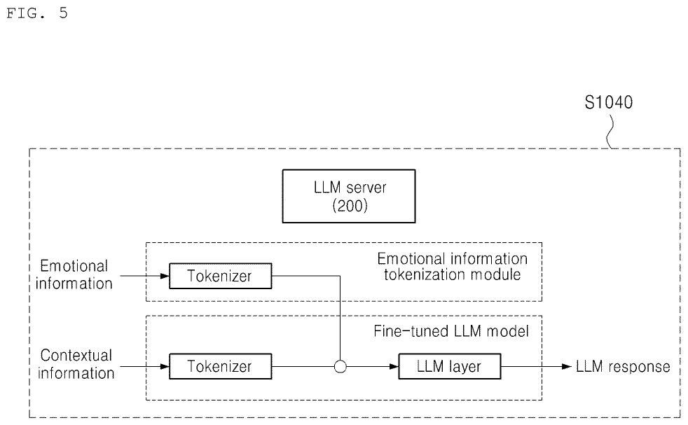

In step S1040 to be described later, FIGS. 3 and 5 will be referenced together.

FIG. 5 is an exemplary diagram showing a structure of an LLM model used in a server according to one embodiment.

In step S1040, the server 200 may input augmented information retrieved through a RAG technique, decoded emotional information and contextual information into a pre-trained LLM model to derive a response of the LLM model to contextual information reflecting emotional information.

As an example, the server 200 may tokenize emotional information and contextual information, respectively, using a tokenizer, and input each tokenized token into an LLM model to derive a response to the contextual information reflecting the emotional information.

The tokenizer denotes an algorithm that divides natural language into small units that can be processed by a machine. Since inputting emotional information or contextual information as it is into the LLM model can reduce processing efficiency, the server 200 may divide emotional information and contextual information, respectively, into a predetermined unit to generate tokens converted into a numeric vector form using the tokenizer, which is then input into the LLM model.

In step S1050, the server 200 may generate response semantic information that encodes the response of the LLM model and transmit it to the robot 100. That is, the server 200 may not transmit the response of the LLM model as it is to the robot 100, but convert the response of the LLM model into semantic information in an optimized form and transmit the converted semantic information, thereby reducing network bandwidth and improving real-time response speed.

As an example, the server 200 may convert the response of the LLM model into a vector form by utilizing a pre-trained response semantic encoder that includes a transformer-based embedding model (e.g., BERT, T5, GPT embedding layer, etc.) that encodes the response of the LLM model. Additionally, in a process of generating response semantic information, rather than simple text conversion, a vector representation reflecting the emotional nuances or conversation context of the response may be generated. To this end, a post-processing step may be performed to optimize the response in consideration of emotional and contextual information.

In step S1060, the robot 100 may decode response semantic information to output a response to the user's utterance. To this end, the robot 100 may perform a process of converting response semantic information received from the server 200 into a text or speech form that the user can understand.

As an example, the robot 100 may restore response semantic information into human-understandable sentences by utilizing a pre-trained response semantic decoder that includes a transformer-based natural language generation model (e.g., GPT, T5, BERT-based decoder) that converts the response semantic information into natural language sentences.

Additionally, the robot 100 may perform speech synthesis by utilizing a text-to-speech (TTS) model (e.g., Tacotron 2, FastSpeech 2, VITS, etc.) that converts converted text into speech, thereby outputting a speech response to the user's utterance. Additionally, a process of decoding response semantic information may include a post-processing process that adjusts the tone or expression manner of the response in consideration of the user's emotional state and conversation context. For example, when an emotionally soft response is needed, the robot may adjust its tone to output a more empathetic expression, and when a formal conversation is needed, it may adjust its literary style to output a more formal response.

As described above, the robot 100 may store an emotional semantic encoder, a contextual semantic encoder, and a response semantic encoder, which are trained in advance, and the server 200 may store an emotional semantic decoder, a contextual semantic decoder, a response semantic decoder, and an LLM model, which are trained in advance.

Hereinafter, an ‘emotional semantic encoder’, a ‘contextual semantic encoder’, and a ‘response semantic encoder’ are collectively referred to as ‘encoder’, and an ‘emotional semantic decoder’, a ‘contextual semantic decoder’, and a ‘response semantic decoder’ are collectively referred to as a ‘decoder’.

Meanwhile, the foregoing training process of the encoder, the decoder, and the LLM model may be performed in a single training device (e.g., a computing device of an entity who develops and distributes the system 10 of the present disclosure).

As an example, a single training device may be designed to perform an entire process from step S1010 to step S1060 of FIG. 2 in an end-to-end learning manner within the single training device to train the encoder, the decoder, and the LLM model.

That is, the single training device may derive a predicted value by simulating operations from steps S1010 to S1060 using pre-prepared training data (e.g., speech uttered by a specific person, a facial image, and a correct response to the corresponding utterance), and training may be carried out in a manner that minimizes a loss between the predicted value and the correct value of the training data.

Accordingly, the parameters of the encoder, the decoder, and the LLM model included in the single training device may be optimized according to a preset loss function, and each encoder, decoder, and LLM model may be organically trained with one another through an end-to-end learning manner.

In this process, the LLM model may train an added LoRA adapter by applying a low-rank adaptation (LORA) technique while maintaining the parameters of a pre-trained basic LLM model. That is, the LLM model may fine-tune the parameters of a LORA adapter to optimize the generation of a response reflecting emotional semantic information and contextual semantic information without changing the values of the pre-trained basic parameters.

Once training is complete, the single training device may distribute the trained encoder to the robot 100, and distribute the trained decoder and LLM model to the LLM server 200. Through this, a real-time conversation system between the robot 100 and the server 200 may be operated in an optimized state, and natural conversation responses in consideration of emotions and context may be provided.

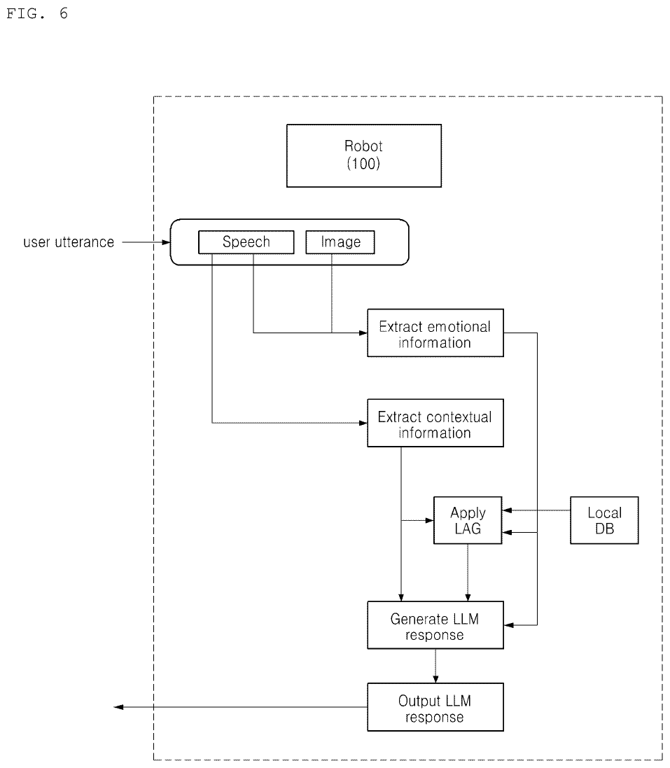

Meanwhile, FIGS. 2 to 5 have been described based on an environment where the robot 100 and the server 200 of the present disclosure are physically separated, but if technology develops further to reach a level where the LLM model can be calculated in the robot 100 itself, a function of the server 200 may also be implemented in a manner of being directly mounted inside the robot 100, as shown in FIG. 6.

FIG. 6 is an exemplary diagram for explaining an embodiment in which an LLM model is mounted on the robot 100 itself according to one embodiment.

Referring to FIG. 6, the robot 100 may receive the user's utterance (speech and image) as an input, extract emotional information and contextual information, then execute an LLM model within the robot 100 to generate a response, and directly output the corresponding response.

In this case, since there is no physical separation between the robot 100 and the server 200 in an environment of FIG. 6, a process of transmitting data to the remote server 200 may be omitted, and accordingly, without the need to separately generate emotional semantic information and contextual semantic information and transmit them to the server 200, the extracted emotional and contextual information may be directly input into the LLM model to generate a response.

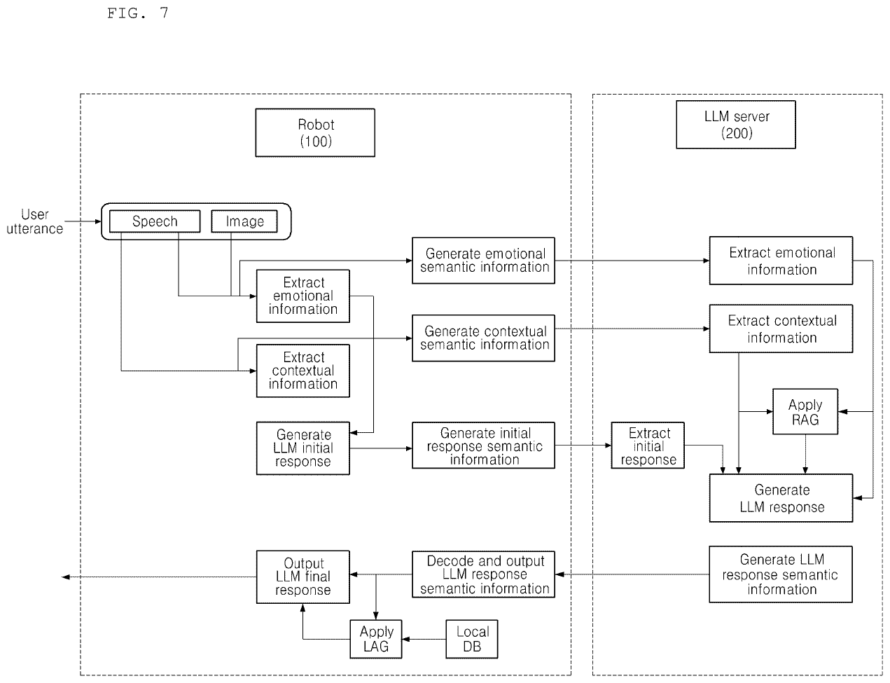

FIG. 7 is an exemplary diagram for explaining a hybrid type conversation generation process in which the robot 100 and the server 200 capable of utilizing an LLM model and a RAG technique interact with each other according to one embodiment.

Referring to FIG. 7, the robot 100 may receive the user's utterance (speech and image), extract emotional information and contextual information, respectively, and then generate an LLM-based initial response from the robot 100 itself based on the extracted information. Then, the corresponding initial response is encoded again into semantic information and transmitted to the server 200.

The server 200 may extract emotional information and contextual information based on not only the initial response semantic information received from the robot, but also the emotional semantic information and contextual semantic information transmitted from the robot, and use them to generate an enhanced response in the LLM model on a side of the server 200. In this process, the server 100 may retrieve external knowledge or related documents by applying the RAG technique as in the foregoing step S1033 to generate augmented information tailored to emotions and context. Accordingly, the generated LLM response on a side of the server 200 is encoded again into semantic information and transmitted to the robot 100.

The robot 100 may decode the LLM response semantic information received from the server to restore it to an initial response in a natural language form, and then apply, when it is determined that the corresponding response is somewhat incomplete or requires additional information, the RAG technique to retrieve and augment related information. When applying RAG, the core keywords or context of the decoded response are input into a local DB to extract the most relevant documents or information.

Accordingly, the robot 100 may input an LLM initial response generated by the robot 100 itself, an LLM response received from the server 200, and augmented information generated by applying the RAG technique by the robot 100 into the LLM model to output a final response.

The structure of FIG. 7 may be referred to as a hybrid system that can improve a response speed of a conversation, information accuracy, and real-time performance by utilizing a high-performance LLM based on the server 200 while performing some processing and supplementation at a level of the robot 100.

Meanwhile, since the detailed description of each step in FIGS. 6 and 7 has already been described in FIG. 3, a partial description of FIG. 3 will be referenced.

According to the foregoing embodiment, the present disclosure may provide an LLM-based conversation generation method in consideration of the emotions of a conversation partner, thereby allowing an LLM-based conversational robot to interact more naturally and emotionally with a human. In particular, unlike a method in which the existing text-based conversation model generates a response by analyzing only the context, the present disclosure may precisely analyze human emotions by utilizing multi-modal sensing. This may make the flow of the conversation smoother and provide an appropriate response to the emotional state of the conversation partner so as to improve the user experience.

In addition, the present disclosure may improve response speed by optimizing data transmission between a robot and an LLM server by introducing a semantic communication method to maintain real-time nature of the conversation, and effectively reflect emotional elements of the conversation while minimizing a calculation burden by utilizing the fine-tuning technique of an LLM.

Through this, the present disclosure not only provides natural conversations that reflect emotions, but also has high practicality that can be utilized in various fields such as customer service, healthcare, and education.

It should be understood that various embodiments of the disclosure and terms used herein are not intended to limit the technical features described in the disclosure to specific embodiments, and include various modifications, equivalents, or alternatives of the embodiments. With regard to the description of the drawings, similar reference numerals may be used for similar or related elements. A singular form of a noun corresponding to an item may include one or more of the things, unless the relevant context clearly indicates otherwise.

In the disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Terms such as “1st”, “2nd”, or “first” and “second” may be used merely to differentiate a corresponding element from another, and do not limit the elements in any other aspect (e.g., importance or order). When an element (e.g., a first element) is referred to as being “coupled” or “connected” to another element (e.g., a second element), with or without the term “functionally” or “communicatively,” it means that the element may be connected to the other element directly (e.g., in a wired manner), in a wireless manner, or through a third element.

The term “module” as used in the disclosure may include a unit implemented in hardware, software or firmware, and may be used interchangeably with terms such as logic, logic block, component, or circuit. A module may be an integrally configured component or a minimum unit of the component that performs one or more functions or a part thereof. For example, according to one embodiment, the module may be implemented in a form of an application-specific integrated circuit (ASIC).

Various embodiments of the disclosure may be implemented as software (e.g., a program) including one or more instructions stored in a storage medium (e.g., a memory) that is readable by a device (e.g., an electronic device). The storage medium may include a random access memory (RAM), a memory buffer, a hard drive, a database, an erasable programmable read-only memory (EPROM), an electrically erasable read-only memory (EEPROM), a read-only memory (ROM), and/or the like.

In addition, a processor in embodiments of the disclosure may retrieve at least one instruction from among one or more instructions stored from a storage medium and execute the retrieved instruction. This allows the device to operate to perform at least one function according to the retrieved at least one instruction. The one or more instructions may include a code generated by a compiler or a code executable by an interpreter. The processor may be a general purpose processor, a field programmable gate array (FPGA), an application specific integrated circuit (ASIC), a digital signal processor (DSP), and/or the like.

The device-readable storage medium may be provided in a form of a non-transitory storage medium. Here, the term ‘non-transitory’ simply means that the storage medium is a tangible device and does not include a signal (e.g. electromagnetic waves), and this term does not differentiate between a case where data is stored semi-permanently and a case where the data is temporarily on the storage medium.

A method according to various embodiments disclosed in the disclosure may be included and provided in a computer program product. The computer program product may be traded as a commodity between a seller and a buyer. The computer program product may be distributed in a form of a device-readable storage medium (e.g., compact disc read only memory (CD-ROM)), or be distributed (e.g., downloaded or uploaded) online via an application store (e.g., PlayStore) or directly between two user devices (e.g., smartphones). In the case of online distribution, at least part of the computer program product may be at least temporarily stored or temporarily generated in the device-readable storage medium, such as a manufacturer's server, a server of an application store, or a server's memory.

According to various embodiments, each element (e.g., a module or a program) of the above-described elements may include a single entity or a plurality of entities. According to various embodiments, one or more of the aforementioned elements or operations may be omitted, or one or more other elements or operations may be added. Alternatively or additionally, the plurality of elements (e.g., modules or programs) may be integrated into a single element. In such a case, the integrated element may perform one or more functions of each of the plurality of elements in the same or similar manner to those performed by a corresponding one of the plurality of elements prior to the integration. According to various embodiments, operations performed by a module, a program or another element may be executed sequentially, in parallel, repeatedly, or heuristically, or one or more of the operations may be executed in a different order, omitted, or one or more other operations may be added.

### REFERENCE SIGNS LIST

10: System
100: Robot
200: LLM server
110: Memory
120: Processor
130: Input/output interface
140: Communication interface

1. A method of performing by a robot conversation generation system including a robot and an LLM server, the method comprising operations of:
acquiring, by the robot, the speech and image of an uttering user;
encoding, by the robot, the speech and the image to generate emotional semantic information, and encoding the speech to generate contextual semantic information to transmit the contextual semantic information and the emotional semantic information to the LLM server;
decoding, by the LLM server, the emotional semantic information to extract the user's emotional information derivable from the speech and the image, decoding the contextual semantic information to extract contextual information including text included in the speech, and applying a RAG technique to the emotional information and the contextual information to generate augmented information;
inputting, by the LLM server, the emotional information, the contextual information, and the augmentation information into an LLM model to derive a response of the LLM model to the contextual information reflecting the emotional information;
encoding, by the LLM server, the response to generate response semantic information and transmit it to the robot; and
decoding, by the robot, the response semantic information to output a response to the user's utterance.

2. The method of claim 1, wherein the speech comprises:
text information and audio information of content uttered by the user, and
wherein the image comprises:
image information including the user's face object.

3. The method of claim 1, wherein the generating of the emotional semantic information comprises:
encoding the speech and the image based on a pre-trained emotional semantic encoder to generate emotional semantic information.

4. The method of claim 3, wherein the emotional semantic encoder comprises:
a CNN-based network that analyzes a frequency spectrum of the speech to extract speech features.

5. The method of claim 4, wherein the emotional semantic encoder further comprises:
a ResNet-based network that extracts image features from a user's facial expression included in the image.

6. The method of claim 1, wherein the generating of the contextual semantic information comprises:
encoding the speech based on a pre-trained contextual semantic encoder to generate contextual semantic information.

7. The method of claim 6, wherein the contextual semantic encoder comprises:
a speech-to-text (STT) network that converts speech into text.

8. The method of claim 7, wherein the contextual semantic encoder further comprises:
a text embedding network that extracts text features from the converted text.

9. The method of claim 1, wherein the extracting of the emotional information comprises:
decoding the emotional semantic information based on a pre-trained emotional semantic decoder to extract a user's emotional information derivable from the speech and the image.

10. The method of claim 9, wherein the emotional semantic decoder comprises:
a softmax layer that converts the emotional semantic information into a preset emotional class probability distribution to output emotional information including information on the probability distribution.

11. The method of claim 10, wherein the emotional semantic information comprises:
speech features extracted by analyzing the frequency spectrum of the speech and image features extracted from the user's facial expression included in the image, and
wherein the emotional semantic decoder comprises:
a cross-attention layer that generates a context vector that combines the features for the speech features and the image features by applying a cross-attention mechanism; and
a softmax layer that converts the context vector into a preset emotion class probability distribution to output emotion information including information on the probability distribution.

12. The method of claim 1, wherein the extracting of the context information comprises:
decoding the contextual semantic information based on a pre-trained context semantic decoder to extract context information including text included in the speech.

13. The method of claim 12, wherein the contextual semantic decoder comprises:
a transformer-based natural language generation model that converts text features included in the contextual semantic information into natural language sentences.

14. The method of claim 1, wherein the deriving of the response comprises:
tokenizing, by the server, the emotional information and the contextual information based on a tokenizer and inputting each token into the LLM model to derive a response to the contextual information reflecting the emotional information.

15. The method of claim 14, wherein the encoding of the response comprises:
generating response semantic information from the response based on a pre-trained response semantic encoder including a transformer-based embedding model encoded by the LLM server, and
wherein the decoding of the response semantic information comprises:
restoring, by the robot, the response from the response semantic information based on a pre-trained response semantic decoder including a transformer-based natural language generation model.

16. The method of claim 1, wherein the training of an encoder included in the robot and a decoder and an LLM model included in the LLM server is designed in a structure in which an entire process from the acquiring operation to the outputting operation is performed in a single training device to train in an end-to-end learning manner in which the parameters of the encoder, the decoder and the LLM model are updated together so as to minimize a loss between a predicted value and a correct value output as the single training device performs the acquiring operation or the outputting operation on the training data, then the encoder that has completed training is stored in the robot, and the decoder and the LLM model that have completed training are stored in the LLM server.

17. The method of claim 16, wherein the LLM model fine-tunes, based on a low-rank adaptation (LORA) technique, the parameters of a LoRA adapter so as to optimize the generation of a response reflecting the emotional semantic information and contextual semantic information by the LORA adapter additionally trained by the single training device while maintaining the parameters of a basic LLM model.

18. The method of claim 17, wherein the encoder comprises:
an emotional semantic encoder that encodes, by the robot, the speech and the image to generate emotional semantic information and a contextual semantic encoder that encodes the speech to generate contextual semantic information,
wherein the decoder comprises:
an emotional semantic decoder that decodes the emotional semantic information to extract the user's emotional information derived from the speech and the image, and a contextual semantic decoder that decodes the contextual semantic information to extract contextual information including text included in the speech, and
wherein the LLM model comprises:
a tokenizer that tokenizes the emotional information and the contextual information, and an LLM layer that receives each token as an input to derive an LLM response for the contextual information reflecting the emotional information.

19. A robot conversation generation system including a robot and an LLM server, the system performing operations of:
acquiring, by the robot, the speech and image of an uttering user;
encoding, by the robot, the speech and the image to generate emotional semantic information, and encoding the speech to generate contextual semantic information to transmit the contextual semantic information and the emotional semantic information to the LLM server;
decoding, by the LLM server, the emotional semantic information to extract the user's emotional information derivable from the speech and the image, decoding the contextual semantic information to extract contextual information including text included in the speech, and applying a RAG technique to the emotional information and the contextual information to generate augmented information;
inputting, by the LLM server, the emotional information, the contextual information, and the augmentation information into an LLM model to derive a response of the LLM model to the contextual information reflecting the emotional information;
encoding, by the LLM server, the response to generate response semantic information and transmit it to the robot; and
decoding, by the robot, the response semantic information to output a response to the user's utterance.

20. A computer program stored on a computer-readable recording medium, the program comprising instructions that perform operations of:
when a server and a client terminal perform predetermined operations in a robot conversation generation system,
acquiring, by the robot, the speech and image of an uttering user;
encoding, by the robot, the speech and the image to generate emotional semantic information, and encoding the speech to generate contextual semantic information to transmit the contextual semantic information and the emotional semantic information to the LLM server;
decoding, by the LLM server, the emotional semantic information to extract the user's emotional information derivable from the voice and the image, decoding the contextual semantic information to extract contextual information including text included in the speech, and applying a RAG technique to the emotional information and the contextual information to generate augmented information;
inputting, by the LLM server, the emotional information, the contextual information, and the augmentation information into an LLM model to derive a response of the LLM model to the contextual information reflecting the emotional information;
encoding, by the LLM server, the response to generate response semantic information and transmit it to the robot; and
decoding, by the robot, the response semantic information to output a response to the user's utterance.
